(19) United States
(12) Patent Application Publication
(10) Pub. No.: US 2012/0092887 A1
(43) Pub. Date: Apr. 19, 2012

(54) BACKLIGHT MODULE AND DISPLAY APPARATUS

(75) Inventor: Meihao Wu, Guangdong (CN)

(73) Assignee: SHENZHEN CHINA STAR OPTOELECTRONICS TECHNOLOGY CO., LTD., Shenzhen (CN)

(21) Appl. No.: 12/996,657

(22) PCT Filed: Nov. 23, 2010
(86) PCT No.: PCT/CN10/79033

§ 371 Date: Dec. 7, 2010

(30) Foreign Application Priority Data
Oct. 15, 2010 (CN) 201010509564.X

(51) Int. Cl. F21V 7/22

(52) U.S. Cl. 362/606; 362/609

(57) ABSTRACT

The present invention provides a backlight module and a display apparatus. The backlight module comprises a circuit board, a plurality of light sources and a reflective layer. The light sources have lighting surfaces and are electrically connected to the circuit board. The reflective layer flushes with the lighting surfaces of the light sources. Alternatively, the height difference between the reflective layer and the lighting surfaces of the light sources is less than 1 mm for reducing the height difference between the reflective layer and the lighting surfaces of the light sources. The present invention can raise the utilization rate of the reflective light.

### FIELD OF THE INVENTION

The present invention relates to a backlight module and a display apparatus, and more particularly to a backlight module and a display apparatus for raise the utilization rate of the reflective light thereof.

### BACKGROUND OF THE INVENTION

Liquid crystal displays (LCDs) have been widely applied in electrical products. Currently, most of LCDs are backlight type LCDs which comprise a liquid crystal panel and a backlight module. According to the position of the backlight source, the backlight module can be a side-light type or a direct-light type in order to provide LCDs with backlight.

Taking the direct-light type backlight module with light emitting diodes (LEDs) for example, the backlight module uses the LEDs to be light sources. In the LED backlight module, LEDs are generally disposed on a circuit board, and a reflective sheet or a reflective plate can be attached between or around the LEDs for reflecting the light thereof.

However, since a package height of the LEDs on the circuit board is obviously larger than a height of the reflective sheet attached on the circuit board, there is a height difference between lighting surfaces of the LEDs and a reflective surface of the reflective sheet. The light of the LEDs is difficult to be reflected in the region of the height difference, and thus the light can not be used efficiently, thereby reducing the light utilization rate of the LEDs.

As a result, it is necessary to provide a backlight module and a display apparatus to solve the problems existing in the conventional technologies, as described above.

### SUMMARY OF THE INVENTION

A primary object of the present invention is to provide a backlight module, and the backlight module comprises: a circuit board; a plurality of light sources having lighting surfaces, wherein the light sources are electrically connected to the circuit board; a reflective layer disposed around the light sources, wherein the reflective layer and the lighting surfaces of the light sources are positioned at the same side of the circuit board; and at least one supporting unit disposed between the circuit board and the reflective layer to support the reflective layer.

Another object of the present invention is to provide a display apparatus, and the display apparatus comprises: a display panel; and a backlight module comprising: a circuit board; a plurality of light sources having lighting surfaces, wherein the light sources are electrically connected to the circuit board; a reflective layer disposed around the light sources, wherein the reflective layer and the lighting surfaces of the light sources are positioned at the same side of the circuit board; and at least one supporting unit disposed between the circuit board and the reflective layer to support the reflective layer.

A further object of the present invention is to provide a backlight module, wherein the backlight module comprises: a circuit board including a plurality of through holes; a plurality of light sources inserted in the through holes, wherein the light sources have lighting surfaces, and the light sources are electrically connected to the circuit board; and a reflective layer disposed on the circuit board, wherein the reflective layer and the lighting surfaces of the light sources are positioned at the same side of the circuit board.

A further object of the present invention is to provide a display apparatus, and the display apparatus comprises: a display panel; and a backlight module comprising: a circuit board including a plurality of through holes; a plurality of light sources inserted in the through holes, wherein the light sources have lighting surfaces, and the light sources are electrically connected to the circuit board; and a reflective layer disposed on the circuit board, wherein the reflective layer and the lighting surfaces of the light sources are positioned at the same side of the circuit board.

In one embodiment of the present invention, the at least one supporting unit are a plurality of column units.

In one embodiment of the present invention, the reflective layer is a reflective plate, a reflective sheet or a reflective coating layer coated on the supporting unit.

In one embodiment of the present invention, the supporting unit is in the form of a plate-shape and includes a plurality of through holes configured to insert the light sources, and the circuit board and the reflective layer are disposed at the two opposite sides of the supporting unit, respectively.

In one embodiment of the present invention, the reflective layer flushes with the lighting surfaces of the light sources.

In one embodiment of the present invention, the circuit board comprises an electrically conductive layer and a dielectric layer, and the electrically conductive layer is formed on the dielectric layer, and the supporting unit is disposed on the electrically conductive layer of the circuit board.

In one embodiment of the present invention, the height difference between the reflective layer and the lighting surfaces of the light sources is less than 1 mm.

In one embodiment of the present invention, the height difference between the reflective layer and the lighting surfaces of the light sources is less than 100 μm.

In one embodiment of the present invention, the backlight module further comprises a light guide plate, and the light sources and the circuit board are disposed at one side of the light guide plate.

The backlight module and the display apparatus of the present invention can reduce the height difference between the reflective layer and the lighting surfaces of the light sources for reducing the light loss in the height difference region and raising the utilization rate of the reflective light.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a cross-sectional view showing a backlight module and a display panel according to a first embodiment of the present invention;

FIG. 2 is a partially cross-sectional view showing the backlight module according to the first embodiment of the present invention;

FIG. 3 is a cross-sectional view showing another portion of the backlight module according to the first embodiment of the present invention;

FIG. 4 is a partially cross-sectional view showing the backlight module according to the second embodiment of the present invention;

FIG. 5 is a partially cross-sectional view showing the backlight module according to the third embodiment of the present invention; and

FIG. 6 is a partially cross-sectional view showing the backlight module according to the fourth embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

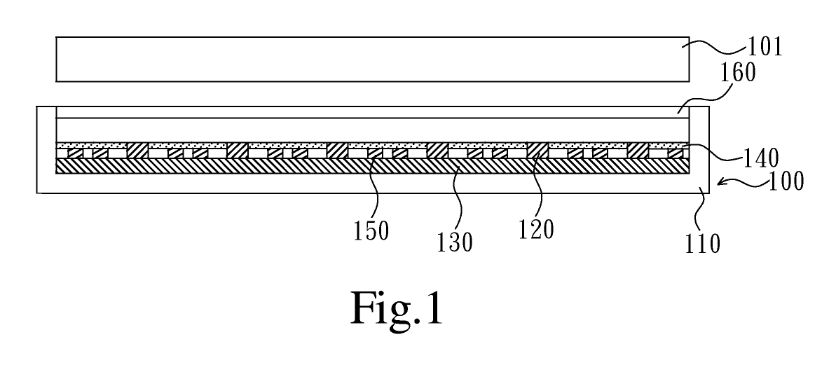

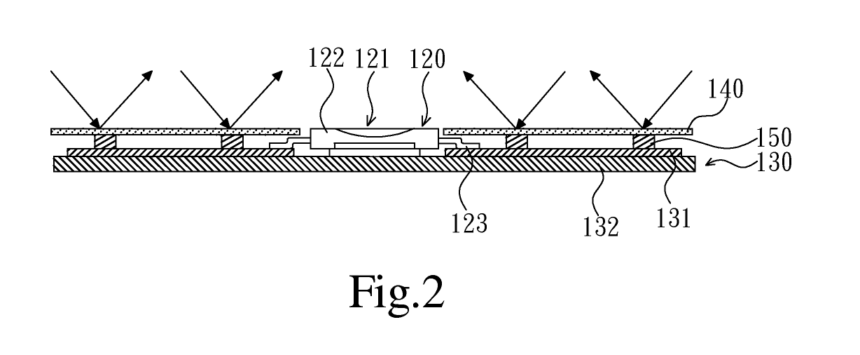

Referring to FIG. 1 and FIG. 2, FIG. 1 is a cross-sectional view showing a backlight module and a display panel according to a first embodiment of the present invention, and FIG. 2 is a partially cross-sectional view showing the backlight module according to the first embodiment of the present invention. The backlight module 100 of the present embodiment may be a direct-light type backlight module disposed opposite to a display panel 101, thereby forming a display apparatus (such an LCD apparatus). The display panel 101 may be a liquid crystal display panel. The backlight module 100 may comprises a back bezel 110, a plurality of light sources 120, a circuit board 130, a reflective layer 140, at least one supporting unit 150 and at least one optical film 160.

Referring to FIG. 1 again, the back bezel 110 of the present embodiment may be made of an opaque material, such as plastic, metal or any combination material thereof for carrying the light sources 120, the circuit board 130 and the optical films 160.

Referring to FIG. 1 and FIG. 2 again, the circuit board 130 is disposed on the back bezel 110. The circuit board 130 may be a printed circuit board (PCB) or a flexible printed circuit (FPC). The circuit board 130 comprises an electrically conductive layer 131 and a dielectric layer 132. The electrically conductive layer 131 is formed on the dielectric layer 132 for electrically connecting with the light sources 120. The electrically conductive layer 131 is preferably made of a metal material and is, for example, a copper foil layer.

The light sources 120 are disposed on the circuit board 130 and electrically connected to the electrically conductive layer 131 thereof for providing light to the display panel 101. The light sources 120 of the present embodiment may be light emitting diodes (LEDs), organic light emitting diodes (OLEDs), electro-luminescence (ELs) devices or light bars.

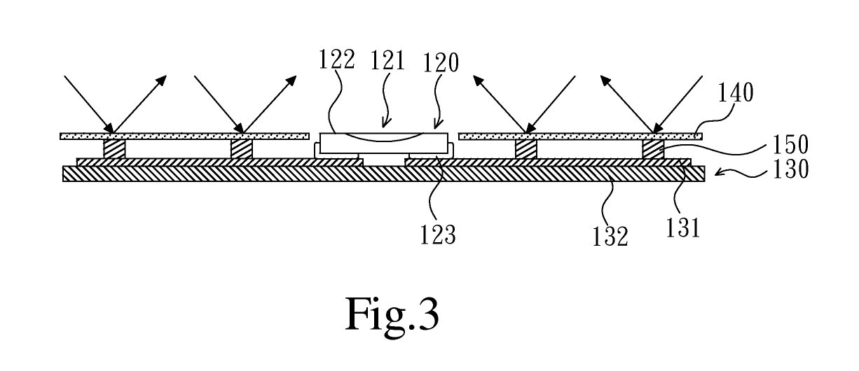

Each of the light sources 120 comprises a lighting surface 121, a package body 122 and two electrode leads 123. The package body 122 may be formed by packaging a LED chip, and exposes the lighting surface 121 and the electrode leads 123. The electrode leads 123 are disposed at two opposite sides of the package body 122, and electrically connected to the circuit board 130 by a surface mount technology (SMT). In this embodiment, the package of the light sources 120 may be a small outline package. That is, the electrode leads 123 are disposed at two opposite sides of the LED chip and bent outside to be electrically connected to the circuit board 130 (referring to FIG. 2). Referring to FIG. 3 again, the electrode leads 123 may also be bent inside to be electrically connected to the circuit board 130.

Referring to FIG. 2 again, the supporting unit 150 of the present embodiment is disposed between the circuit board 130 and the reflective layer 140 for supporting the reflective layer 140. The supporting unit 150 may be made of an insulating material, such as plastic or rubber material. The at least one supporting unit 150 may be a plurality of column units and disposed on the circuit board 130 by welding, bonding or screwing. In this embodiment, the supporting units 150 are disposed on the electrically conductive layer 131 of the circuit board 130.

Referring to FIG. 2 again, the reflective layer 140 is disposed on the supporting units 150 and formed between or around the light sources 120 for reducing a height difference between the reflective layer 140 and the lighting surfaces 121 of the light sources 120. The reflective layer 140 of the present embodiment may be a reflective plate or a reflective sheet for reflecting light. The reflective layer 140 may be made of a highly reflective material, such as Ag, Al, Au, Cr, Cu, In, Ir, Ni, Pt, Re, Rh, Sn, Ta, W, Mn, any alloy combination thereof, white reflective paint with etiolation-resistant and heat-resistant properties or any combination thereof.

Referring to FIG. 2 again, by means of the supporting of the supporting units 150, the reflective surface of the reflective layer 140 may substantially flush with the lighting surfaces 121 of the light sources 120. Alternatively, the height difference between the reflective surface of the reflective layer 140 and the lighting surfaces 121 of the light sources 120 may be less than 1 mm, for example, preferably less than 100 μm. Therefore, in comparison with the conventional backlight module, the height difference between the reflective surface of the reflective layer 140 and the lighting surfaces 121 of the light sources 120 can be eliminated or significantly reduced, thereby reducing the light loss in the height difference region and raising the utilization rate of the reflective light.

The optical film 160 is disposed above the light sources 120 for improving the light uniformity and light efficiency of the light sources 120. The optical film 160 of the present embodiment may be for example a diffuser, a prism sheet, a turning prism sheet, a brightness enhancement film, a dual brightness enhancement film, a diffused reflective polarizer film or any combination thereof disposed above the light sources 120.

Therefore, the backlight module 100 of the present embodiment can use the at least one supporting unit 150 to reduce the height difference between the reflective layer 140 and the lighting surfaces 121 of the light sources 120 for improving the utilization rate of the reflective light of the backlight module 100.

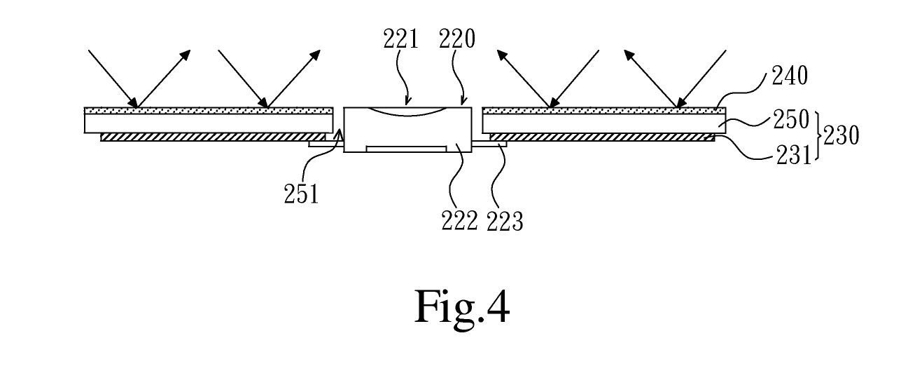

Referring to FIG. 4, a partially cross-sectional view showing the backlight module according to a second embodiment of the present invention is illustrated. Only the difference between the embodiment and the first embodiment are described hereinafter, and the similar construction therebetween is not stated in detail herein. In comparison with the first embodiment, the supporting unit 250 of the second embodiment may be in the form of a plate-shape. The dielectric layer 232 of the circuit board 230 can directly be used to be the supporting unit 250. At this time, the electrically conductive layer 231 is formed on one side of the supporting unit 250, and the reflective layer is formed on the other side of the supporting unit 250 opposite to the electrically conductive layer 231. The supporting unit 250 includes a plurality of through holes 251 for receiving and inserting the light sources 220. The package bodies 222 of the light sources 220 are disposed in the through holes 251 of the supporting unit 250, and the electrode leads 223 thereof extend out the package bodies 222 to be electrically connected to the electrically conductive layer 231. The lighting surfaces 221 of the light sources 220 can flush with the reflective surface of the reflective layer 240. Alternatively, the height difference between the reflective surface of the reflective layer 240 and the lighting surfaces 221 of the light sources 220 may be less than 1 mm, for example, preferably less than 100 μm. In this embodiment, the reflective layer 240 may be a reflective sheet or a reflective plate. Alternatively, the reflective layer 240 may also be a reflective coating layer which may be directly coated or printed on the other side of the supporting unit 250 opposite to the electrically conductive layer 231 by using a highly reflective material. Therefore, the backlight module 200 of the present embodiment can use the supporting unit 250, i.e. the dielectric layer of the circuit board 230, in cooperation with the through holes 251 to reduce the height difference between the reflective layer 240 and the lighting surfaces 221 of the light sources 220 for improving the utilization rate of the reflective light.

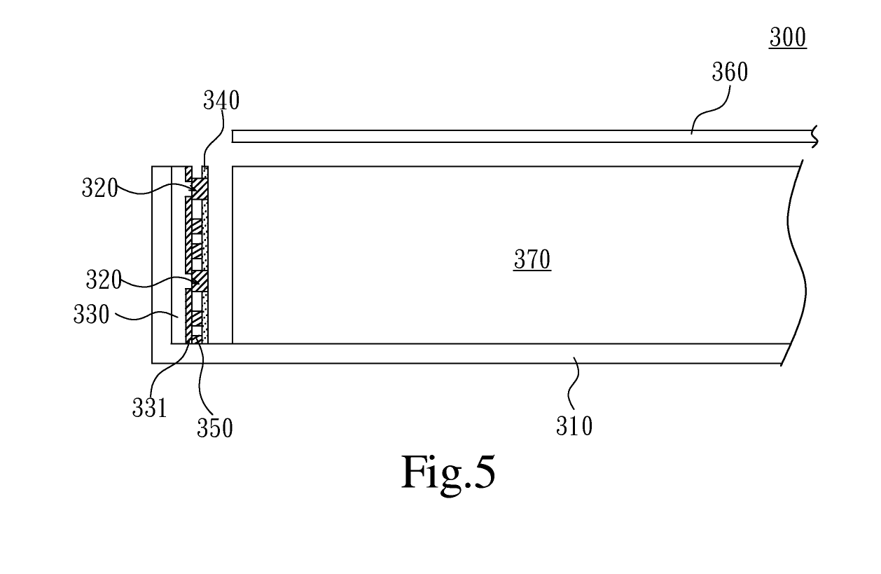

Referring to FIG. 5, a partially cross-sectional view showing the backlight module according to a third embodiment of the present invention is illustrated. Only the difference between the embodiment and the first embodiment are described hereinafter, and the similar construction therebetween is not stated in detail herein. In this embodiment, the backlight module 300 may be a side-light type backlight module which may comprise a back bezel 310, a plurality of light sources 320, a circuit board 330, a reflective layer 340, at least one supporting unit 350, at least one optical film 360 and a light guide plate 370. The light guide plate 370 is disposed on the back bezel 310. The light sources 320 and the circuit board 330 can be assembled as a light bar disposed at one side of the light guide plate 370 for emitting light thereto. The reflective layer 340 is formed around the light sources 320 for reflecting the light thereof. The supporting unit 350 is formed between the electrically conductive layer 331 of the circuit board 330 and the reflective layer 340 for reducing the height difference between the reflective layer 340 and the lighting surfaces 321 of the light sources 320. The optical film 360 is disposed above the light guide plate 370 for improving the uniformity and efficiency of the light outputted from the light guide plate 370.

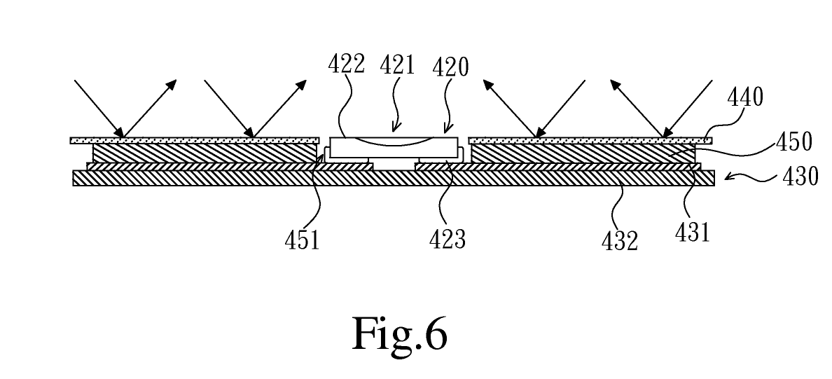

Referring to FIG. 6, a partially cross-sectional view showing the backlight module according to a fourth embodiment of the present invention is illustrated. Only the difference between the embodiment and the first embodiment are described hereinafter, and the similar construction therebetween is not stated in detail herein. In comparison with the first embodiment, the supporting unit 450 of the fourth embodiment may be in the form of a plate-shape and disposed on the circuit board 430. The supporting unit 450 includes a plurality of through holes 451 for receiving and inserting the light sources 420. The package bodies 422 of the light sources 420 are disposed in the through holes 451 of the supporting unit 450, and the electrode leads 423 are disposed at two opposite sides of the package bodies 422, and electrically connected to the electrically conductive layer 431 of the circuit board 430 by the surface mount technology (SMT). The electrode leads 423 are, for example, bent inside to be electrically connected to the circuit board 430 (referring to FIG. 6). Furthermore, the electrode leads 423 may also be disposed at two opposite sides of the LED chip and bent outside to be electrically connected to the circuit board 430. The lighting surfaces 421 of the light sources 420 can flush with the reflective surface of the reflective layer 440. In this embodiment, the reflective layer 440 may be a reflective plate, a reflective sheet or a reflective coating layer coated on the surface of the supporting unit 450. Therefore, the backlight module 400 of the present embodiment can use the supporting unit 450 of the plate-shape to reduce the height difference between the reflective layer 440 and the lighting surfaces 421 of the light sources 420 for improving the utilization rate of the reflective light.

As described above, the backlight module and the display apparatus of the present invention can use the supporting unit to increase the height of the reflective layer for reducing the height difference between the reflective layer and the lighting surfaces of the light sources, thereby reducing the light loss in the height difference region and raising the utilization rate of the reflective light.

The present invention has been described with a preferred embodiment thereof and it is understood that many changes and modifications to the described embodiment can be carried out without departing from the scope and the spirit of the invention that is intended to be limited only by the appended claims.

1. A display apparatus, characterized in that: the display apparatus comprises:
a display panel; and
a backlight module comprising:
a circuit board;
a plurality of light sources having lighting surfaces, wherein the light sources are electrically connected to the circuit board;
a reflective layer disposed around the light sources, wherein the reflective layer and the lighting surfaces of the light sources are positioned at the same side of the circuit board; and
at least one supporting unit disposed between the circuit board and the reflective layer to support the reflective layer, wherein the supporting unit is in the form of a plate-shape and includes a plurality of through holes configured to insert the light sources, and the circuit board and the reflective layer are disposed at the two opposite sides of the supporting unit respectively, and a height difference between the reflective layer and the lighting surfaces of the light sources is less than 1 mm.

2. The display apparatus according to claim 1, characterized in that: the reflective layer is a reflective plate, a reflective sheet or a reflective coating layer coated on the supporting unit.

3. The display apparatus according to claim 1, characterized in that: the height difference between the reflective layer and the lighting surfaces of the light sources is less than 100 μm.

4. The display apparatus according to claim 1, characterized in that: the backlight module further comprises a light guide plate, and the light sources and the circuit board are disposed at one side of the light guide plate.

5. A backlight module, characterized in that: the backlight module comprises:
a circuit board;
a plurality of light sources having lighting surfaces, wherein the light sources are electrically connected to the circuit board;
a reflective layer disposed around the light sources, wherein the reflective layer and the lighting surfaces of the light sources are positioned at the same side of the circuit board; and
at least one supporting unit disposed between the circuit board and the reflective layer to support the reflective layer.

6. The backlight module according to claim 5, characterized in that: the at least one supporting unit are a plurality of column units.

7. The backlight module according to claim 5, characterized in that: the reflective layer is a reflective plate or a reflective sheet.

8. The backlight module according to claim 5, characterized in that: the supporting unit is in the form of a plate-shape and includes a plurality of through holes configured to insert the light sources, and the circuit board and the reflective layer are disposed at the two opposite sides of the supporting unit, respectively.

9. The backlight module according to claim 8, characterized in that: the reflective layer is a reflective plate, a reflective sheet or a reflective coating layer coated on the supporting unit.

10. The backlight module according to claim 5, characterized in that: the reflective layer flushes with the lighting surfaces of the light sources.

11. The backlight module according to claim 5, characterized in that: the circuit board comprises an electrically conductive layer and a dielectric layer, and the electrically conductive layer is formed on the dielectric layer, and the supporting unit is disposed on the electrically conductive layer of the circuit board.

12. The backlight module according to claim 5, characterized in that: the height difference between the reflective layer and the lighting surfaces of the light sources is less than 1 mm.

13. The backlight module according to claim 5, characterized in that: the height difference between the reflective layer and the lighting surfaces of the light sources is less than 100 μm.

14. The backlight module according to claim 5, characterized in that: the backlight module further comprises a light guide plate, and the light sources and the circuit board are disposed at one side of the light guide plate.

15. A backlight module, characterized in that: the backlight module comprises:
a circuit board including a plurality of through holes;
a plurality of light sources inserted in the through holes, wherein the light sources have lighting surfaces, and the light sources are electrically connected to the circuit board; and
a reflective layer disposed on the circuit board, wherein the reflective layer and the lighting surfaces of the light sources are positioned at the same side of the circuit board.

16. The backlight module according to claim 15, characterized in that: the reflective layer is a reflective plate, a reflective sheet or a reflective coating layer coated on the circuit board.

17. The backlight module according to claim 15, characterized in that: the reflective layer flushes with the lighting surfaces of the light sources.

18. The backlight module according to claim 15, characterized in that: the height difference between the reflective layer and the lighting surfaces of the light sources is less than 1 mm.

19. The backlight module according to claim 15, characterized in that: the height difference between the reflective layer and the lighting surfaces of the light sources is less than 100 μm.

20. The backlight module according to claim 15, characterized in that: the backlight module further comprises a light guide plate, and the light sources and the circuit board are disposed at one side of the light guide plate.
